(19) United States
(12) Patent Application Publication
(10) Pub. No.: US 2006/0117313 A1
(43) Pub. Date: Jun. 1, 2006

(54) Method for patching firmware in memory device

(76) Inventors: You-Ying Yeh, Hsin-Chu City (TW); Hsin-Chang Wu, Hsin-Chu City (TW); Guide Chi-Pei Wang, Hsin-Chu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/285,032

(22) Filed: Nov. 23, 2005

(30) Foreign Application Priority Data
Nov. 23, 2004 (TW) 93136053

(51) Int. Cl. G06F 9/44

(52) U.S. Cl. 717/168

(57) ABSTRACT

The present invention is related to a method for patching a firmware in a memory device. At least one functional patching program is stored at a read/write memory location inside the memory device, thereby correcting or updating a functional program in the firmware. Once the function is used, it can be directly replaced by the program stored in the memory location without re-burning or replacing the whole firmware so that the purposes of reducing cost and simplifying update firmware can be achieved.

### BACKGROUND OF THE INVENTION

1. Field of the Invention

The present invention stores a functional patching program at a read/write memory location inside a memory device, thereby correcting or updating a functional program in a firmware so as to achieve the purposes of reducing cost and simplifying firmware update.

2. Description of Related Art

Because the data processing of computers is becoming increasingly complicated, the conventional storage device, which has a small capacity or is not easily carried, is already insufficient for the access of general files. Therefore, computer manufacturers are devoted to finding a portable and repeatedly readable/writable technology. However, since this kind of portable device with large capacity should match a convenient and commonly practiced transmission protocol and interface, the general portable storage device on the market, e.g., the memory card for a digital video camera/camera, conveniently portable USB drive or recording pen, was created. All of them take a flash memory as a main memory device.

Reference is made to FIG. 1 showing the structure of a conventional USB drive (for example, TW patent No. 555,047), including a main body 10, a USB connector 14 for connecting with a USB interface on the computer, and a cover 12 for protection. The main body 10 further comprises numerous control circuits and memory elements; for example, as shown in FIG. 1, a memory substrate 16 bears a memory chip 15, and a control substrate 18 bears a control chip of the USB drive (not shown). The control chip controls the function of read/write and signal transmission in the USB drive, in which some micro codes are used as command for controlling. However, mostly, these micro codes are stored in a ROM whose cost is lower or in a memory for only one-time storage, i.e., the so-called firmware between the hardware and the software. Once a compatibility problem with the software and hardware occurs the firmware is damaged, the whole device may be unworkable, and then, the solution is either to replace or to re-burn the chip. Not only the cost, but also the customers are not protected.

Reference is made to FIG. 2, showing a structural schematic view of a conventional dynamic patching method for a chip firmware (TW patent No. 330,291). This conventional technology utilizes a more expensive and a re-burnable or a flash memory for replacing the ROM in order to solve the problem that the built-in ROM of a digital signal processor (DSP) or a microprocessor (MPU) cannot be repaired or has to be replaced or abandoned owing to a partial destruction. Therefore, this conventional technology provides a small read/write memory for making up the defect of ROM. As shown in FIG. 2, a chip read-only memory 24 is included, in which an error module 23 is further included. This is the case of when mounting inside the device or external to a small read/write memory 20, in which a control area 21 and a patch area 22 are divided, where a patch module 221 for patching the error module 23 is stored in the patch area 22, and the control area 21 is used to define the addresses of each program and module of the chip read-only memory 24 and further used to direct the addresses of the patch area 22 and the patch module 221 therein.

During the operation of the above-mentioned configuration, if an error module 23 is found in the chip read-only memory 24, then in accordance with the defined corresponding addresses, the operation will directly be transferred to the patch module 221 for continuing execution.

Although the conventional technology shown in FIG. 2 solves the problem of ROM exchange, the cost of the read/write memory 20 is still increased, and whether the original ROM is usable or not, the cost of a built-in or external memory as manufacturing is necessary, too.

### SUMMARY OF THE INVENTION

The present invention is a method for patching a firmware in a memory device, characterized in that at least one functional patch is stored at a read/write memory location inside the memory device, thereby correcting or updating a functional program in the firmware so as to achieve the purposes of reducing cost and simplifying firmware update.

The patch method of the firmware includes initiating the system, detecting if the firmware function of one or plural memory location needs to be patched, selecting use of the function firmware, determining if the firmware function has a patching program, and using the patching program loaded into the memory block and corresponding to the firmware function.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a structure of a conventional USB drive;

FIG. 2 is a structural schematic view showing a dynamic patch method of the chip firmware in the prior art;

FIG. 3 is schematic view showing a firmware patching device of a memory device according to the present invention;

FIG. 4 is a flow chart showing loading of a firmware patching program of the memory device into a memory block according to the present invention; and

FIG. 5 is a flow chart showing a system operation of the method for a firmware patch in the memory device according to the present invention.

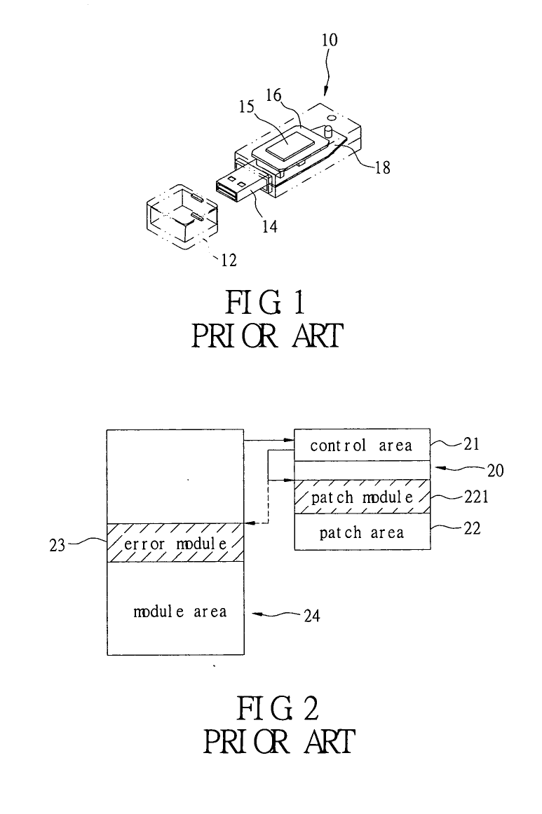

### DETAILED DESCRIPTION OF PREFERRED EMBODIMENTS

The present invention utilizes the configuration of a conventional USB drive or memory card, such as, for example, an SD, CF or MS, and also utilizes the memory device therein for storing the patch program. When the firmware in the device executes a certain function and finds a need for patching, the present invention uses the patch program stored in the read/write memory block directly without exchanging or re-burning the firmware.

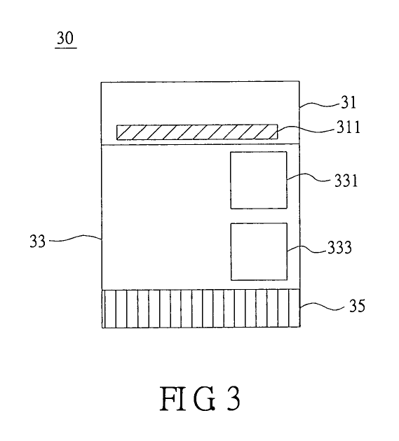

As shown in FIG. 3, which is a schematic view of a firmware patching device of a memory device, a memory device 30 can be separated into three portions. One is a memory block 31, which is a location for data storage, i.e., a read/write non-volatile memory such as the conventional flash memory. Another is a control unit 33 for controlling an input/output signal and a data transmission of the memory device 30 and also a data access of the memory block 31. The control unit 33 at least includes a microprocessor 331 for digitally processing signals and a firmware 333 for storing micro codes, and the micro codes are used as command for controlling. These micro codes are mostly stored in a ROM, whose cost is lower, or a memory for only one-time storage. The others are plural signal pins 35 electrically connected to the memory device 30, thereby connecting with a connection port of a computer system. All program commands and data flows are transmitted through the signal pins 35.

In the above-mentioned memory block 31, a partial continued or not continued program-patching block 311 has already and previously been defined according to the preset invention. A program status of the program-patching block 311 is indicated by plural flags defined by the micro codes in the firmware. If the functional program in the firmware 333 needs to be patched or updated, then a burning program is used to memorize the patch program at the pre-defined location and the flag is set as 1 (on) for notifying the system. Therefore, when it needs a certain function and a flag thereof is indicated as 1, the functional program inside the program-patching block 311 will be used to replace the original old program in the firmware 333.

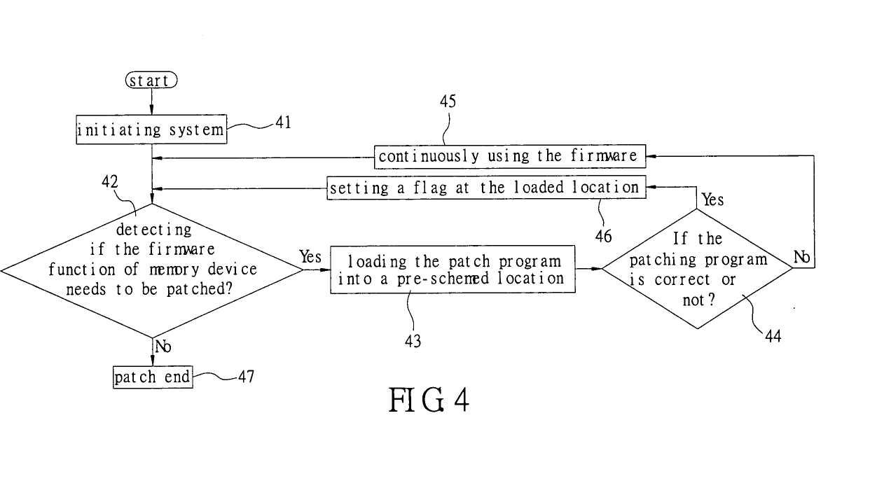

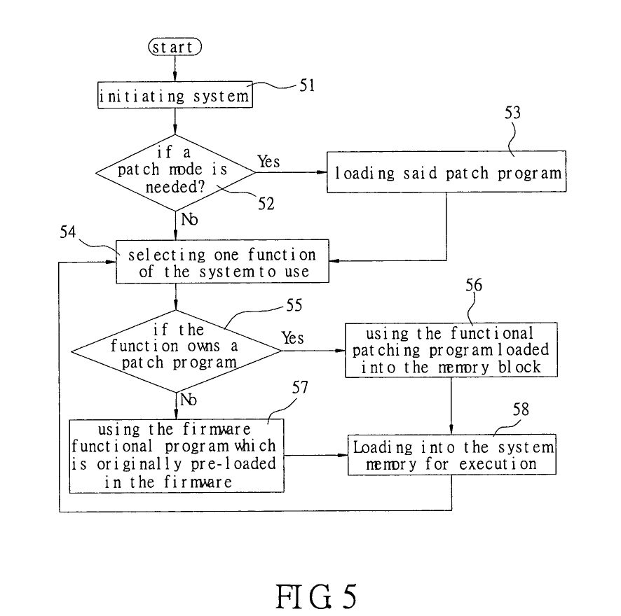

FIG. 4 is a flow chart illustrating how the memory device according to the present invention loads the firmware patching program into the memory block. Under a patching mode of the memory device:

Step 41: When the system is activated, namely, a system initialization is started, the micro codes in the firmware are loaded into the microprocessor for preparing to receive a control signal and an memory data access signal from an apparatus connected with this memory device, and a step of defining an address of the pre-schemed program-patching block is further included;

Set 42: Then, any update data or any destruction in the firmware function that needs patching is detected;

Step 43: If a patch is needed, the burning program is employed to load the patched functional program for the patch-needed function into the program-patching block of the memory block;

Step 44: Whether the patching program, including the version thereof or compatibility, is correct or not is detected;

Step 45: If the patching program is damaged or there is a problem of unmatchable version or compatibility, then the original functional program in the firmware is continuously used;

Step 46: If not, the loaded location sets a flag to 1 (on), where the step of setting one or plural flags is employed to define that the firmware function of the memory device has been replace by a corresponding patching program; and

These above-described steps are repeatedly performed until every patch-needing function has been patched.

Step 47: When no more patches are needed, the process ends.

FIG. 5 is a flow chart of system operation showing a method for patching a firmware in the memory device according to the present invention. This memory device at least includes a memory block and program-patching block therein, and microprocessor and firmware in the control unit. The method of patching includes steps of:

Step 51: After the system is activated, namely, the initialization is started, then drivers in the firmware are loaded into a system memory, generally a RAM, in a computer system connected to this memory device and the microprocessor is also initiated, and further, the step of defining an address of the pre-schemed program-patching block is included;

Step 52: Whether a patch mode is needed is redetermined;

Step 53: If the patch mode is needed, the procedure enters the steps for loading a patching program, as shown in FIG. 4, and subsequently enters Step 54;

Step 54: If it is negative, a system operation mode is initiated and a user may choose to use one function of the system;

Step 55: Whether the function needs a patch program according to the flag set to each function in the firmware is 0 (off) or 1 (on) is determined;

Step 56: If the function has a patch program, then the patch program loaded into the memory block corresponding to the firmware function is used, and then the procedure enters Step 58;

Step 57: If the function does not own a corresponding patch program, then the firmware functional program originally pre-loaded in the firmware is used;

Step 58: The function program stored in the program-patching block or in the firmware is loaded into the system memory for execution according to the conditions of Steps 56 and 57;

Afterward, the procedure enters a loop for selecting functions in the system to be used or will continue a step of determining if needs to use other firmware function or if there is patching program.

The present invention employs partial capacity of the original read/write memory used for data storage in the memory device for leaving the patch without additional memory so as to achieve the purposes of patching or updating firmware.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for patching a firmware in a memory device, wherein said memory device at least comprises a memory block and a program-patching block therein, a microprocessor and a firmware, said method comprising steps of:
initiating a system;
detecting if the system is under a patch mode;
selecting to use a function of said firmware;
determining if said firmware function has a patching program; and
using said patching program loaded into said memory block and corresponding to said firmware function.

2. The method as claimed in claim 1, wherein in said detecting step, if a result is positive, then steps of loading said patching program are performed, comprising:
loading said patching program of said firmware function into a pre-designed program-patching block; and
setting at least one flag.

3. The method as claimed in claim 2, wherein said setting step is used to indicate replacement of said firmware function of said memory device by said corresponding patching program.

4. The method as claimed in claim 1, wherein said determining step is performed by setting a flag.

5. The method as claimed in claim 1, wherein in said determining step, if a result is negative, then said originally pre-loaded firmware functional program in said firmware is used.

6. The method as claimed in claim 1, wherein after said using step, further comprises steps of:
loading said firmware functional program into a system memory for execution; and
determining if other firmware functions are to be used.

7. The method as claimed in claim 1, wherein in said determining step, if a result is positive, said using step is performed.

8. The method as claimed in claim 7, wherein said step of initiating the system further comprises a step of defining an address of said pre-schemed program-patching block.

9. The method as claimed in claim 1, wherein said memory block is a read/write non-volatile memory.

10. A method for patching a firmware in a memory device, wherein steps of loading a patching program into a memory block for patching comprises:
initiating a system;
detecting if a firmware function of one or plural memory device needs to be patched;
loading a patching program of said firmware into a pre-schemed program-patching block, if a result is positive; and
setting at least one flag.

11. The method as claimed in claim 10, wherein said step of initiating the system further comprises a step of defining an address of said pre-schemed program-patching block.

12. The method as claimed in claim 10, wherein the steps are repeatedly operated for completing said patch.

13. The method as claimed in claim 10, wherein said memory block is a read/write non-volatile memory.

14. The method as claimed in claim 10, wherein said setting step is used to indicate replacement of said firmware function of said memory device by said corresponding patching program.

15. A method for patching a firmware in a memory device, wherein steps of loading a patching program into a memory block for patching comprises:
initiating a system;
detecting if a firmware function of one or plural memory devices needs to be patched;
loading a patching program of said firmware into a pre-schemed program-patching block, if a result is positive;
determining if said patching program is correct; and
setting at least one flag.

16. The method as claimed in claim 15, wherein in said determining step, if the result is negative, indicating damage or compatibility problems of said patching program, then said original functional program in said firmware is continuously used.

17. The method as claimed in claim 15, wherein said step of initiating the system further comprises a step of defining an address of said pre-schemed program-patching block.

18. The method as claimed in claim 15, wherein the steps are repeatedly performed for completing said patch.

19. The method as claimed in claim 15, wherein said memory block is a read/write non-volatile memory.

20. The method as claimed in claim 15, wherein said setting step is used to indicate replacement of said firmware function of said memory device by said corresponding patching program.
